(19) United States
(12) Patent Application Publication
(10) Pub. No.: US 2012/0251857 A1
(43) Pub. Date: Oct. 4, 2012

(54) INSERT FOR A RECHARGEABLE BATTERY PART

(76) Inventors: Norman Neuhold, Graz (AT); Nikolaus Chorinsky, Graz (AT)

(21) Appl. No.: 13/395,318

(22) PCT Filed: Sep. 9, 2010
(86) PCT No.: PCT/AT2010/000322

§ 371 Date: May 23, 2012

(30) Foreign Application Priority Data
Sep. 10, 2009 (AT) A 1422/2009

(51) Int. Cl. H01M 2/02; H01M 2/12; H01M 10/52; H01M 2/10; H01M 2/22; H01M 10/04; H01M 2/04; H01M 2/30

(52) U.S. Cl. 429/82; 429/151; 429/99; 429/97; 429/179

(57) ABSTRACT

The invention relates to an insert (1), which can be inserted into a storage battery part (2) of an electrically operated tool, in particular a hand-guided tool with at least one handle for holding the tool, wherein the insert (1) comprises several battery cells (3), which are connected to one another in a current-conducting manner. According to the invention it is provided that the insert (1) has an openable housing (4) in which the battery cells (3) are inserted, wherein the battery cells (3) are connected in a current-conducting manner to conductor bars (5) attached to the inside of the housing (4). Furthermore, the invention relates to a storage battery part (2) with an insert (1) of this type as well as an electrically operated tool, comprising the storage battery part (2).

The invention relates to an insert, which can be inserted into a storage battery part of an electrically operated tool, in particular a hand-guided tool with at least one handle for holding the tool, wherein the insert comprises several battery cells, which are connected to one another in a current-conducting manner.

Furthermore, the invention relates to a storage battery part of an electrically operated tool, in particular a hand-guided tool with at least one handle for holding the tool, wherein several battery cells are enclosed in the storage battery part and the storage battery part is closed in an openable manner by an outer part, and an electrically operated tool that has a storage battery part of this type.

Furthermore, the invention relates to a storage battery part of an electrically operated tool, in particular a hand-guided tool with at least one handle for holding the tool, wherein several battery cells are arranged in the storage battery part and connected to one another in a current-conducting manner.

Furthermore, the invention relates to a battery cell for a storage battery part of an electrically operated tool, in particular a hand-guided tool with at least one handle for holding the tool, wherein the battery cell has a base body with a raised terminal and edges as well as an outside insulation surrounding the edges.

Electrically operated tools, for example, screwdrivers, are often used in a hand-guided manner or are operated by human hand even in the industrial sphere. Although it is basically possible to connect the tools to an electric mains, storage battery parts are often provided, so that the tools can be used independently of the location of a power supply.

The storage battery parts provided as a rule accommodate in the interior several battery cells that are connected to one another, for example, by conductor wires soldered or welded to terminals of the battery cells so that the battery cells can be incorporated into an electric circuit in the region of two end positions of the conductor wires in order to ensure an autonomous power supply of a tool.

In particular in the industrial sphere, where high capacities are desired, it is usual for a storage battery part to be designed as cost-effectively as possible. As a rule, the storage battery part is composed merely of a shell of an injection-molded plastic, in the interior of which the battery cells connected to one another in a current-conducting manner are arranged as an insert. The storage battery part can be recharged many times after discharge. However, ultimately the battery cells have a limited service life, which is why charging is finally no longer possible.

When a storage battery part can no longer render possible its function of a power supply, in practice the procedure is to dispose of the storage battery part as a whole, although only the battery cells per se are no longer functional and/or contacts are worn. Alternatively, it is also possible for the storage battery part, which as a rule is embodied in an openable manner, to be opened and the insert or individual battery cells to be replaced. However, this alternative is seldom used in practice. On the one hand tool users are reluctant to open the storage battery part, since the battery cells could have leaked out and handling such leaked-out battery cells or the insert can then be dangerous. On the other hand a repair of an insert is complex, even when this is carried out by trained staff. In particular, individual defective battery cells have to be detached from the insert and new battery cells have to be inserted by soldering or welding, which is time consuming and thus also cost intensive. An insertion of individual battery cells has not hitherto been considered, since an individual battery cell that is not optimally bonded in particular in the case of vibrations can already lead to stoppage of the tool and thus to a loss of production.

The object of the invention is to eliminate or reduce these disadvantages and in particular to provide an insert which can be replaced safely and simply for an identical insert, even by a tool user, so that the shell of the storage battery part can be further used, and in which optionally in a simple manner individual battery cells can be replaced, if desired.

Another object of the invention is to disclose battery cells of the type mentioned at the outset, which can be used without the risk of a tool stoppage for storage battery parts.

The first object is attained with an insert of the type mentioned at the outset in that the insert has an openable housing in which the battery cells are inserted, wherein the battery cells are connected in a current-conducting manner to conductor bars attached to the inside of the housing.

One advantage achieved with the invention is to be seen in that due to the provided housing, the insert can be replaced as a whole without any danger at all. If, alternatively, a repair is planned, in which the housing of the insert is not replaced, but only one or more battery cells are replaced, this can be carried out easily. Since conductor bars attached to the inside of the housing are provided, which connect the individual battery cells in a current-conducting manner, only the defective battery cell or cells need to be replaced, wherein, in contrast to the prior art, complex soldering or welding work can be omitted. In both cases the shell of the storage battery part can be further used.

Usually the battery cells are embodied in a cylindrical manner. Within the scope of the invention the housing then has a housing part on the base, which housing part extends approximately over a height of the battery cells, and a housing cover detachably fastened thereto. This provides the advantage that the individual battery cells with a replacement of the same are already held securely or in a largely positionally stable manner in the housing part on the base before the housing cover is attached. In this context it can be advantageously provided that the conductor bars are arranged on the housing part on the base and, in plan view offset thereto, on the housing cover. The individual battery cells can thereby be easily incorporated into an electric circuit thereby. In this case preferably outwardly projecting contacts are arranged on the housing cover, which are connected to the conductor bars in a current-conducting manner, so that a connection to those contacts of a storage battery part can be produced via which or by which a power supply of a tool is ensured. With respect to a positional stability of the battery cells, it can furthermore be provided that vertical posts are arranged in the housing protruding from a base of the housing and the housing has a contour adapted at least in part to the battery cells so that the battery cells are held in position in a manner resistant to shear forces. It is particularly preferred thereby that fastening means engage in the posts, with which fastening means the housing cover is attached to the housing part on the base so that no further structural adjustments of the base side housing part are necessary with regard to a fastening of the housing cover.

The housing can be composed of any desired materials, but is preferably composed of a plastic, since the housing is not intended to be current-conducting.

Furthermore, it is advantageous that a damping mat is arranged outside on the base of the housing so that a wobbling of the insert in the storage battery part is avoided. The damping mat is preferably composed of a plastic part acting resiliently or of a foam part and can optionally be fiber-reinforced.

It is also advantageous that the housing has ventilation slots in order to avoid an overheating of the insert during charging of the battery cells.

According to the depicted advantages, objects of the invention are to disclose a storage battery part of the type mentioned at the outset or an electrically operated tool with such a storage battery part, wherein disadvantages of the prior art are avoided. These objects are attained by a storage battery part of the type mentioned at the outset in which an insert according to the invention is inserted or an electrically operated tool of the type mentioned at the outset with a storage battery part of this type.

The first object of the invention can alternatively also be attained if, with a storage battery part of an electrically operated tool, in particular a hand-guided tool with at least one handle for holding the tool, wherein several battery cells are arranged in the storage battery part, which battery cells are connected to one another in a current-conducting manner, the storage battery part has a removable cover and conductor bars are arranged on the cover and in the storage battery part on a side of the storage battery part lying opposite the cover, with which conductor bars the battery cells are connected in a current-conducting manner.

With this variant, although a replacement of one or more cells and thus a direct contact therewith is at any rate necessary in the event of a loss of function, the advantage is provided of a cost-effective production of the storage battery part as a whole. In practice this can at least make up for the disadvantage that individual cells must be handled directly, where applicable, to maintain functionality. In contrast to soldered or welded packets of storage batteries, as they are conventionally used with tools in industry, which operate with relatively high currents, a replacement of individual cells can now also take place. The provided conductor bars thereby ensure that an optimal contact and thus a power supply is always guaranteed, namely also in the case of vibrations.

It can be provided thereby that the conductor bars are arranged on the cover and in plan view offset thereto on an opposite side of the storage battery part. Thus individual battery cells can be connected in series relatively easily without a welding or soldering of the same being necessary.

In order to be able to hold individual battery cells particularly firmly fixed in one position and thus to ensure the desired power supply even in the case of vibrations, vertical posts can be arranged in the storage battery part protruding from the opposite side of the storage battery part, which can be made to align with posts protruding from a base of the cover with the arrangement of the cover on the storage battery part, in order to form continuous mounts for the battery cells.

Furthermore, it can be provided that outer mounts for the battery cells are provided in the storage battery part, wherein the outer mounts are preferably composed of a plastic. A particularly positionally stable fixing of individual battery cells in the storage battery part is thus achieved in a simple manner. In this connection it can be provided for reasons of simple production and to save space, that the outer mounts bear partially against an inside of the storage battery part, but are separated from one another.

The further object of the invention is attained with a battery cell of the type mentioned at the outset in that a non-conducting, preferably elastic element is positioned between the base body and the insulation on the terminal side, so that the terminal is set back with respect to a level of the preferably elastic element, wherein the insulation fixes the preferably elastic element and that a conducting wafer is fixed on or in the preferably elastic element, which wafer is in areal contact with the terminal and is embodied to be wider than it.

One advantage achieved with the battery cell according to the invention is to be seen in particular in that a favorable bonding of the battery cell is possible due to the widened embodiment of the conducting wafer. The risk of a loss of power is thereby reduced even in the case of vibrations and a use of individual battery cells is possible. Furthermore, the provided preferably elastic element ensures that the raised terminal, as a rule the positive terminal, and the further terminal or negative terminal are insulated from one another so that short-circuits are prevented.

The preferably elastic element can be, e.g., of silicone, although other non-conducting materials can also be used, for example plastics, such as polycarbonates.

It is advantageous if an adhesive ring is arranged between the preferably elastic element and the base body of the battery cell. The elastic element can thereby be easily fixed on the battery cell in a positionally stable manner before the insulation, generally a heatshrinking sleeve, is arranged around the battery cell. Furthermore, the adhesive ring can also be resilient and thus support the preferably elastic but also optionally rigid element. The insulation or the heatshrinking sleeve surrounds the battery cell including the preferably elastic element and the conducting wafer positioned therein so that a stable assembly is achieved.

It is particularly preferred if the wafer has journals that engage in recesses in the preferably elastic element so that the wafer is detachably attached to the preferably elastic element. This permits an easy connection of wafer and elastic element during manufacture, before they are placed together on a battery cell and an insulation or a heatshrinking sleeve is arranged around the battery cell.

Further features, advantages and effects of the invention are shown by the exemplary embodiment presented below. The drawings, to which reference is made in the presentation of the exemplary embodiment, show:

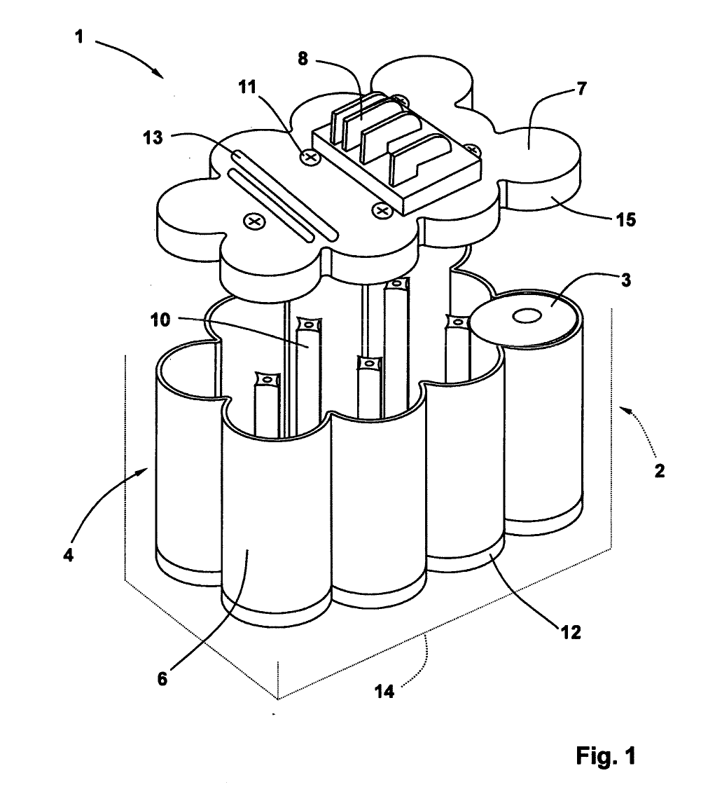

FIG. 1 a diagrammatic persepective representation of a storage battery part according to the invention;

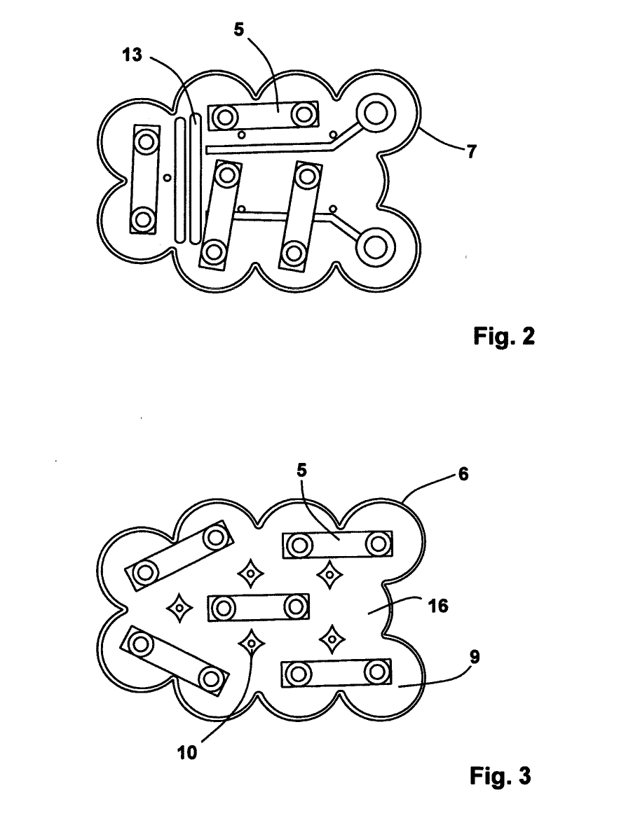

FIG. 2 a diagrammatic plan view of a housing cover of an insert according to the invention;

FIG. 3 a diagrammatic plan view of a housing part on a base of an insert according to the invention;

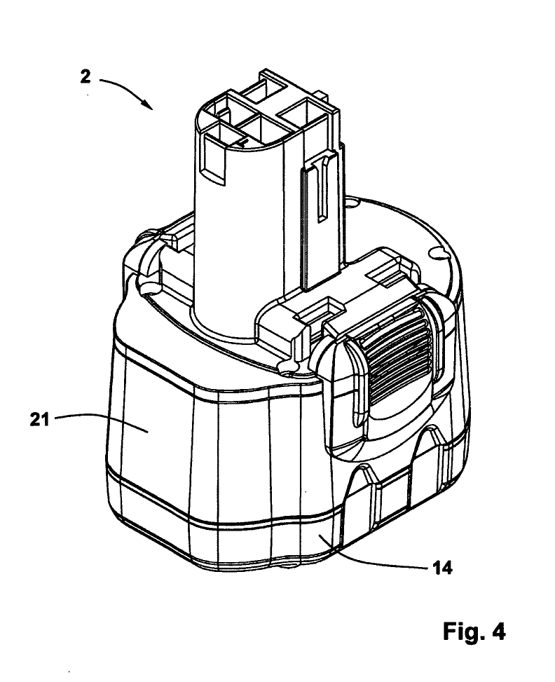

FIG. 4 a storage battery part;

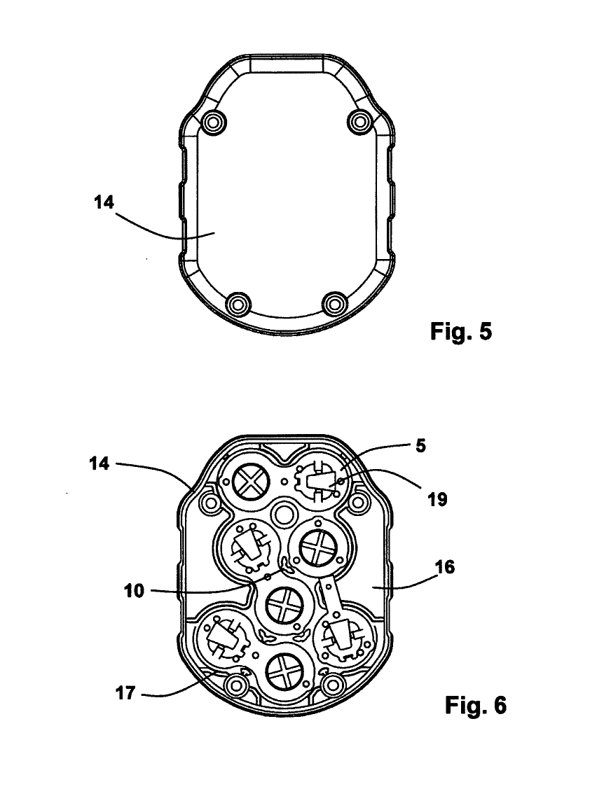

FIG. 5 a plan view on the base of a cover of the storage battery part according to FIG. 4;

FIG. 6 a plan view on an inside of the cover shown in FIG. 5;

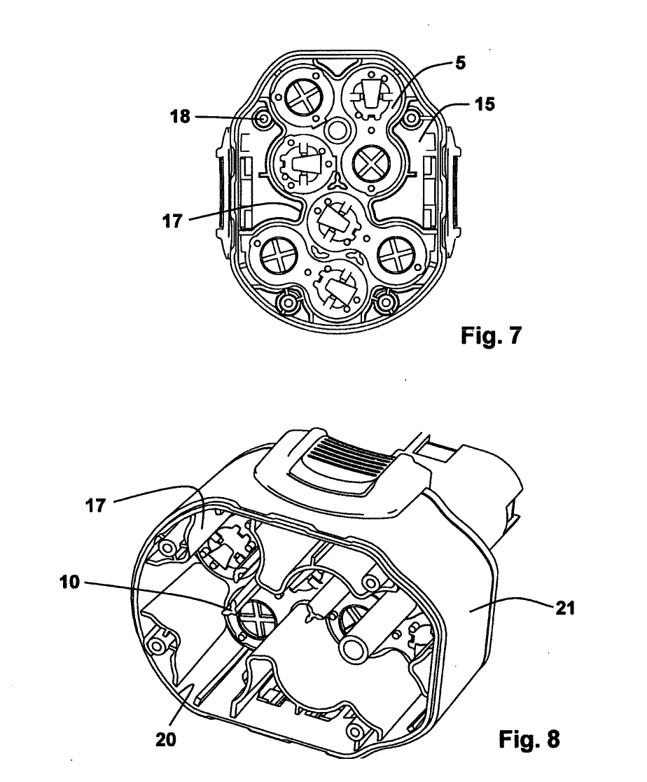

FIG. 7 a plan view on the base of the storage battery part according to FIG. 4 with the cover removed;

FIG. 8 a perspective view of the storage battery part with the cover removed;

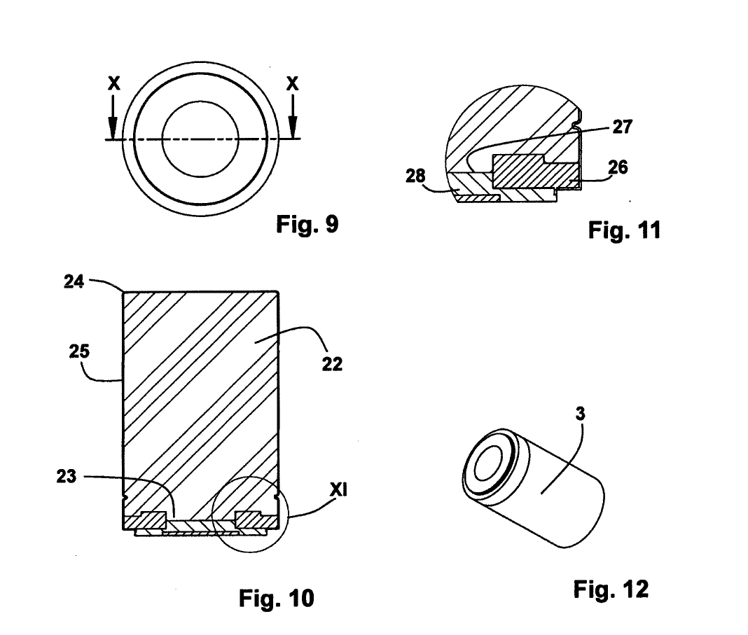

FIG. 9 a plan view of a battery cell;

FIG. 10 a cross section along the line X-X in FIG. 9;

FIG. 11 an enlarged section according to the circle XI in FIG. 10;

FIG. 12 a perspective view of a storage cell.

FIGS. 1 through 3 show diagrammatically a storage battery part 2 and an insert 1 respectively. The storage battery part 2 comprises a removable cover, not shown, which is detachably fastened to a base body 14, only indicated in FIG. 1, of the storage battery part 2. The base body 14 is attached to the cover such that after the fastening of the cover, the insert 1 is completely enclosed, but a current-conducting contact to a tool to be supplied can be established by attaching the storage battery part 2 to the tool. The insert 1 is arranged in the interior of the storage battery part 2, the outer contours of which insert correspond to inner contours of the storage battery part 2, so that the insert 1 can be inserted into the storage battery part 2 in an exactly fitting manner. The insert 1 in turn is shaped on the outside such that cylindrical battery cells 3 located in its interior, only one of which battery cells is shown in FIG. 1, are held at least in part on the circumferential side. On the outside the insert 1 is composed of a housing 4, which is formed of a housing part 6 on the base and a housing cover 7. The housing 4 is formed of a plastic that is 1 to 3 mm thick in cross section, which is rigid at this thickness. The housing cover 7 has an outside edge 15 in the direction of a base 9 of the housing part 6 on the base, which outside edge partially projects beyond the housing part 6 on the base in the fastened condition. The housing cover 7 is detachably fastened to the housing part 6 on the base by fastening means 11, e.g., screws, which thereby engage in posts 10 that are arranged on the base of the housing part 6 on the base. The posts 10 have a dual function: on the one hand the posts 10 as mentioned serve to interact with the fastening means 11, with which the housing cover 7 can be detachably fixed to the housing part 6 on the base. On the other hand, the posts 10 serve to hold the battery cells 3 in interaction with a contour or a circumferential surface of the housing 6 on the base in position in a manner resistant to shear forces. The housing 4 furthermore has a damping mat 12, which serves to prevent the housing 4 or in general the insert 1 from wobbling in the storage battery part 2. The damping mat 12 preferably has a thickness of 2 to 4 mm and can be formed of a foam, for example, a polyurethane foam. It is also possible for the damping mat 12 to be additionally fiber-reinforced, e.g., with glass fibers or other synthetic or optionally also natural fibers. Furthermore, the housing 4 has ventilation slots 13, which are preferably arranged in the housing cover 7, but in principle can also be arranged at other locations, for example, extending vertically on the outside of the housing part 6 on the base. The ventilation slots 13 are used to prevent an overheating of the insert 1 during the charging of the battery cells 3. In this respect in addition a thermal circuit breaker can also be provided, which stops a further charging and thus overheating of the insert 1 if a certain temperature is exceeded. The ventilation slots 13 preferably have a width of less than 1 mm so that on the one hand the desired ventilation and thus a temperature compensation during charging is ensured, but on the other hand not too much dust can enter the insert 1 either. The thermal circuit breaker can be arranged, for example, in a gap 16, in which no battery cell 3 is arranged. However, it is also possible that the insert 1 in plan view is completely equipped with battery cells 3. In this case, the thermal circuit breaker is attached to the housing cover 7 above the battery cells 3.

The insert 1 has several conductor bars 5 arranged apart from one another on the housing cover 7 as well as on the base 9 of the housing part 6 on the base. With the insertion of battery cells 3 into the insert 1, these conductor bars 5 connect the individual battery cells 3 so that they are integrated in a single electrical circuit. To this end the conductor bars 5 are offset to one another in the region of the housing part 6 on the base and of the housing cover 7 and finally end in contacts 8 guided to the outside, with which directly or indirectly a current-conducting connection is ensured to a tool to be supplied. The conductor bars 5 preferably bear resiliently against the housing part 6 on the base and/or the housing cover 7 in order to rule out any loose connections. A cushioning can be simply formed by a silicone support and/or rubber knobs, on which the conductor bars 5 bear.

The insert 1 makes it possible on the one hand that the same can be replaced in a simple manner by an identical insert 1 in that the storage battery part 2 is opened and a new insert 1 is inserted. On the other hand it is also possible that the insert 1 per se after the opening of the storage battery part 2 is opened and individual defective battery cells 3 are easily replaced by a simple exchange.

FIG. 4 shows perspectively a storage battery part 2 of an alternative embodiment variant. A storage battery part of this type is designed for industrial tools such as screwdrivers with peak powers of more than 800 W. FIGS. 5 through 8 show a cover 14 and an interior of the storage battery part 2 in various views. As can be seen, the storage battery part 2 is embodied with a cover 14, which is arranged on the base. The cover 14 is detachably fastened to the storage battery part 2 with screws and can be removed if necessary. The cover 14 forms a base but in other embodiment variants of the storage battery part 2 can also be arranged at the side. In this case the storage battery part 2 is closed on the base or cannot be opened there. The cover 14 with an adjoining region 21 of the storage battery part 2 forms a chamber in which battery cells 3 can be arranged; the cover 14 and the mentioned adjoining region 21, which is embodied circumferentially in approximately the same shape as the cover 14, have a height that is slightly higher than an individual battery cell 3.

Analogously to the first exemplary embodiment several conductor bars 5 are arranged on a base 16 of the cover 14, which conductor bars respectively have two terminal areas for battery cells 3. If necessary, the terminal areas can be embodied in part with a spring or a resiliently acting wafer 19 of a biased spring steel, which promotes a good bonding of individual battery cells 3. If the cover 14 is removed from the storage battery part 2, battery cells 3 can be placed into the storage battery part 2 or can be removed therefrom for replacement. As can be seen from FIGS. 7 and 8, for this purpose a chamber is embodied in the interior of the storage battery part 2, wherein in turn analogously embodied conductor bars 5 are provided on a side 15 lying opposite the cover 14. The conductor bars 5 on the base 16 of the cover 14 on the one hand and the side 15 lying opposite on the other hand are offset with respect to one another so that cylindrical battery cells 3 are switched in series as soon as the cover 14 is attached to the storage battery part 2. Depending on the number of provided places for battery cells 3, it can also be necessary to provide individual places not connected, in addition to the conductor bars 5 in order to achieve the desired series connection.

It can be seen from FIGS. 6 through 8 that posts 10 are arranged on the inside of the cover 14 as well as in the opposite interior of the storage battery part 2, wherein the shorter posts 10 of the cover 14 during the fastening of the same to the storage battery part 2 can be aligned with the longer posts 10 in the interior of the storage battery part 2, so that continuous posts 10 are provided. Battery cells 3 in interaction with outer mounts 17, which likewise are provided congruently on the cover 14 as well as in the interior of the storage battery part 2, can thus be held in position excellently so that a power loss even in the case of vibrations, such as often occur in industrial applications, is virtually ruled out. The outer mounts 17 in part bear against an inside 20, but are separated from one another, so that the inside 20 can also be used for resting on the battery cells 3. A place is optimally used thereby. For example, sensors, e.g., a temperature sensor, or fastening receptacles 18 for the fastening screws of the cover 14 can be arranged in the remaining free spaces.

FIGS. 9 through 12 show a battery cell 3, which preferably is used in an insert 1 or a storage battery part 2 of the type explained above. The battery cell 3 has a base body 22 with a raised terminal 23 and circumferential edges 24, wherein the edges 24 are surrounded by an insulation 25. The insulation 25 is thereby formed by a heatshrinking sleeve of plastic. The base body 22 can be a cell according to the prior art. However, in contrast to the prior art, the battery cell 3 in addition has a preferably elastic element 26, e.g. of silicone. The element 26 is embodied in an annular manner and placed on the side of the raised terminal 23, which is usually the positive terminal, on the base body 22. Optionally, in addition a thin adhesive ring (not shown) can be arranged between the element 26 and the base body 22, which adhesive ring holds the element 26 at least temporarily on the base body 22. The element 26 is embodied with a height so that that the element 26 projects above a level 27 of the raised terminal 23. In addition, a current-conducting wafer 28 is provided, which can be composed of a steel, for example, and is connected to the elastic or optionally rigid element 26. A connection can be designed such that the current-conducting metallic wafer 28 has journals projecting on the circumferential side which engage in recesses of the element 26. The wafer 28 can then be fixed in the element 26 with slight pressure. The wafer 28 has a height such that it contacts the raised terminal 23, which in cross section has a smaller width, in an areal manner under slight pressure. This is supported by the heatshrinking sleeve or insulation 25, which during production after the arrangement of the element 26 together with the wafer 28 attached therein or thereon is applied on the base body 22 around the battery cell so that the element 26 is held firmly. Due to this embodiment of a battery cell 3 undesirable short-circuits between the raised terminal 23 and a further terminal, which as a rule runs on the outside of the battery cell, can be just as effectively avoided as power losses with larger vibrations.

1. An insert (1), which can be inserted into a storage battery part (2) of an electrically operated tool, in particular a hand-guided tool with at least one handle for holding the tool, wherein the insert (1) comprises several battery cells (3), which are connected to one another in a current-conducting manner, characterized in that the insert (1) has an openable housing (4) in which the battery cells (3) are inserted, wherein the battery cells (3) are connected in a current-conducting manner to conductor bars (5) attached to the inside of the housing (4).

2. The insert (1) according to claim 1, characterized in that the battery cells (3) are embodied in a cylindrical manner and the housing (4) has a housing part (6) on the base, which housing part extends approximately over a height of the battery cells (3), and a housing cover (7) detachably fastened thereto.

3. The insert (1) according to claim 2, characterized in that the conductor bars (5) are arranged on the housing part (6) on the base and, in plan view offset thereto, on the housing cover (7).

4. The insert (1) according to claim 2, characterized in that
outwardly projecting contacts (8) are arranged on the housing cover (7), which are connected to the conductor bars (5) in a current-conducting manner.

5. The insert (1) according to claim 2, characterized in that vertical posts (10) are arranged in the housing (4) protruding from a base (9) of the housing (4) and the housing (4) has a contour adapted at least in part to the battery cells (3) so that the battery cells (3) are held in position in a manner resistant to shear forces.

6. The insert (1) according to claim 5, characterized in that fastening means (11) engage in the posts (10), with which fastening means the housing cover (7) is attached to the housing part (6) on the base.

7. The insert (1) according to claim 1, characterized in that the housing (4) is composed of a plastic.

8. The insert (1) according to claim 1, characterized in that a damping mat (12) is arranged outside on the base (9) of the housing (4).

9. The insert (1) according to claim 8, characterized in that the damping mat (12) is composed of a plastic part acting resiliently or of a foam part, wherein the plastic part or the foam part optionally can be fiber-reinforced.

10. The insert (1) according to claim 1, characterized in that the housing (4) has ventilation slots (13).

11. A storage battery part (2) of an electrically operated tool, in particular a hand-guided tool with at least one handle for holding the tool, wherein several battery cells (3) are enclosed in the storage battery part (2) and the storage battery part (2) is closed in an openable manner by an outer part, characterized in that an insert (1) according to claim 1 is inserted.

12. An electrically operated tool, in particular a hand-guided tool with at least one handle for holding the tool, comprising a detachably fastened storage battery part (2) with a removable outer part, wherein one or more battery cells (3) are enclosed in the storage battery part (2), wherein the storage battery part (2) is closed in an openable manner, characterized in that the storage battery part (2) is embodied according to claim 11.

13. A storage battery part (2) of an electrically operated tool, in particular a hand-guided tool with at least one handle for holding the tool, wherein several battery cells (3) are arranged in the storage battery part (2) and connected to one another in a current-conducting manner, characterized in that the storage battery part (2) has a removable cover (14) and conductor bars (5) are arranged on the cover (14) and in the storage battery part (2) on a side (15) of the storage battery part (2) lying opposite the cover (14), with which conductor bars the battery cells (3) are connected in a current-conducting manner.

14. The storage battery part (2) according to claim 13, characterized in that the conductor bars (5) are arranged on the cover (4) and in plan view offset thereto on the opposite side (15) of the storage battery part (2).

15. The storage battery part (2) according to claim 13, characterized in that vertical posts (10) protruding from the opposite side (15) of the storage battery part (2) are arranged in the storage battery part (2), which posts can be aligned with posts (10) protruding from a base (16) of the cover (14) with the arrangement of the cover (14) on the storage battery part (2), in order to form continuous mounts for the battery cells (3).

16. The storage battery part (2) according to claim 13, characterized in that outer mounts (17) for the battery cells (3) are provided in the storage battery part (2), wherein the outer mounts (17) are preferably composed of a plastic.

17. The storage battery part (2) according to claim 16, characterized in that the outer mounts (17) bear in part against an inside (20) of the storage battery part (2), but are separated from one another.

18. An electrically operated tool, in particular a hand-guided tool with at least one handle for holding the tool, comprising a storage battery part (2) according to claim 13.

19. A battery cell (3) for a storage battery part (2) of an electrically operated tool, in particular a hand-guided tool with at least one handle for holding the tool, wherein the battery cell (3) has a base body (22) with a raised terminal (23) and edges (24) as well as an outside insulation (25) surrounding the edges (24), characterized in that that a non-conducting, preferably elastic element (26) is positioned between the base body (22) and the insulation (25) on the terminal side, so that the terminal (23) is set back with respect to a level (27) of the preferably elastic element (26), wherein the insulation (5) fixes the preferably elastic element (26) and that a current-conducting wafer (28) is fixed on or in the preferably elastic element (26), which wafer is in areal contact with the terminal (23) and is embodied to be wider than it.

20. The battery cell (3) according to claim 19, characterized in that the preferably elastic element (26) is composed of silicone.

21. The battery cell (3) according to claim 19, characterized in that an adhesive ring is arranged between the preferably elastic element (26) and the base body (22) of the battery cell (3).

22. The battery cell (3) according to claim 19, characterized in that the wafer (28) has journals that engage in recesses in the preferably elastic element (26), so that the wafer (28) is detachably connected to the preferably elastic element (26).

23. The battery cell (3) according to claim 19, characterized in that the insulation (25) is formed by a heatshrinking sleeve.
